(19) United States
(12) Patent Application Publication
(10) Pub. No.: US 2007/0252973 A1
(43) Pub. Date: Nov. 1, 2007

(54) Position detecting device

(76) Inventor: Ulf Guldevall, Taby (SE)

Correspondence Address: YOUNG & THOMPSON, 745 SOUTH 23RD STREET, 2ND FLOOR, ARLINGTON, VA, 22202, US

(21) Appl. No.: 11/352,341

(22) Filed: Feb. 13, 2006

Related U.S. Application Data
(63) Continuation-in-part of application No. PCT/SE04/01187, filed on Aug. 12, 2004.

(30) Foreign Application Priority Data
Aug. 13, 2003 (SE) 0302205-0

(51) Int. Cl. G01C 3/08; G01B 11/14

(52) U.S. Cl. 356/4.07; 356/614

(57) ABSTRACT

Position detecting device, comprising a photo detection element array having n segments and a parallel arithmetic processing portion that is arranged to identify the segment having maximum intensity by comparing the output values (OV) from the segments of the photo detection element array. The parallel arithmetic processing portion comprises at least one comparing stage that is arranged to successively select/deselect the segments, until the segment having maximum intensity is selected, the first stage receiving the output values OV from respective photo detection element segments as input segments (IS) and any additional stage receiving the output values OV from the preceding stage as input segments IS. There is also provided a rangefinder comprising the position detecting device.

The present invention relates to a position detecting device which enables a position to be detected at high speed and high precision and to a range sensor using the same.

### BACKGROUND OF THE INVENTION

Conventional triangulating rangefinders normally utilize a linear array of photo detecting segments, e.g. photodiodes, which depend on CCD technique or CMOS technique with a multiplexer to serially shift out the output values from each segment or pixel in the array. This serial pixel data stream is thereafter analyzed to find the position for the maximum output value, which is used to calculate the distance to the object of interest. In many applications it is of great importance that the range reading is updated at very high frequencies, up to the GHz range. However, due to the serial reading of output values in most prior art devices it is difficult to achieve sampling rates that exceeds 40 kHz.

EP 0 837 301 discloses a position detecting device and a rangefinder which enables a position to be detected at high speed and high precision. The device comprising a plurality of detection elements in an array arrangement and computing means for processing the signals from the detection elements wherein the detection elements are photo detection elements arranged in a photo detection element array having n segments, the computing means is a parallel arithmetic processing portion, that calculates the segment having maximum intensity by comparing the outputs from the segments of the photo detection element array and furthermore calculates the peak position of the intensity with a precision of a sub-segment based on the outputs from the segments of the photo detection element array.

U.S. Pat. No. 5,245,398 discloses a time-multiplexed multi-zone rangefinder having a photo detection element array with a plurality of segments. The outputs of the photo detection elements are connected to the inputs of an analog multiplexer, in which the signals from a pair comprising two adjacent segments are compared and different pairs are processed subsequently.

U.S. Pat. No. 5,448,359 discloses an electronic evaluation system, which processes n different light intensities from an array of photo detectors to find the one with the highest intensity. This is achieved by means of a threshold, the height of which corresponds to a specified percentage value of the sum of all intensity values. If a plurality of signals exceeds the threshold value, then the corresponding height values Z are to be averaged.

### SUMMARY OF THE INVENTION

The object of the invention is to provide a new position detecting device, that overcomes one or more drawbacks of the prior art. This is achieved by the position detecting device as defined in claim 1.

One advantage with such a device is that it can identify the position of the peak intensity at a high frequency.

Another advantage is that it comprises a simple circuit that may be fabricated on the same chip as the detector segments.

Still another advantage is that it provides the position of the peak segment as a binary code.

Embodiments of the invention are defined in the dependent claims.

### BRIEF DESCRIPTION OF THE DRAWINGS

The invention will be described in detail below with reference to the drawings, in which:

FIG. 1 is a schematic view of one embodiment according to the present invention.

FIGS. 2 to 11 are diagrams that show the operation of a number of embodiments according to the present invention.

FIGS. 12 to 22 are examples of circuit designs (fig. a: design and fig. b: components) for a number of embodiments according to the present invention.

### DETAILED DESCRIPTION OF PREFERRED EMBODIMENTS

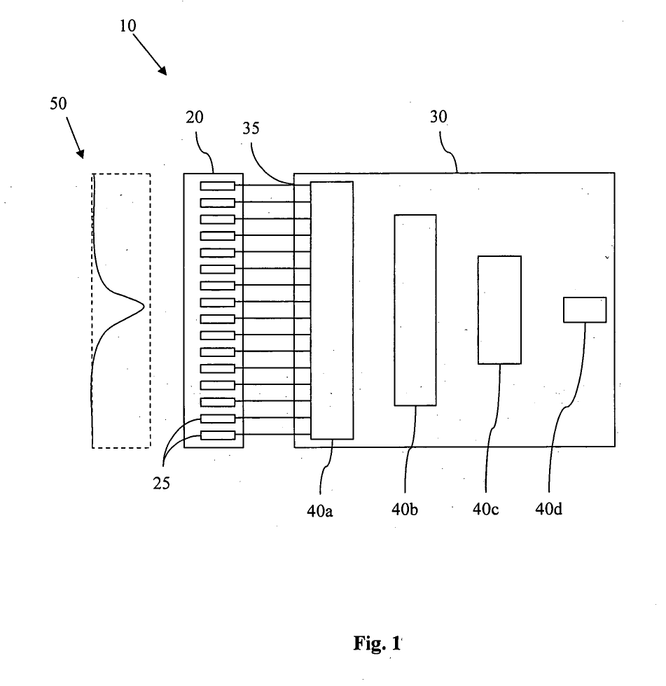

FIG. 1 shows a first embodiment of the position detecting device 10 according to the present invention, comprising a photo detection element array 20 having n=16 segments 25 and a parallel arithmetic processing portion 30 arranged to identify the segment 25 having maximum intensity by comparing the output values (OV) from the segments 25 of the photo detection element array 20. The parallel arithmetic processing portion 30 comprises at least one comparing stage 40a-d that is arranged to successively select/deselect the output values OV from the segments 25, until the segment 25 having maximum intensity is selected. The first stage 40a is arranged to receive the output values OV from respective photo detection element segments 25 as input segments (IS) and the additional stages 40b-d are arranged to receive the output values OV from the preceding stage 40a-c as input segments IS.

According to the present invention, the parallel arithmetic processing portion 30 may comprise any suitable number of comparing stages 40a-d, depending on the number of segments 25 in the photo detection element array 20, and the type of comparing stages 40a-d that are used.

When the photo detection element array 20 is irradiated by detection light, the signals forming the intensity distribution as illustrated by an intensity curve 50 in FIG. 1, are output from the segments 25 of the photo detection element array 20 at the same time. The signals output from the segments 25 are given to the parallel arithmetic processing portion 30, which has n input terminals 35. The photo detection element array 20 preferably is a photodiode array, but it may be comprised of any suitable photo detecting array arrangement that can respond at high speed.

The photo detection element array 20 preferably has a response bandwidth up to about 1 GHz and its performance should not deteriorate by executing high speed sampling. Due to the parallel design the parallel arithmetic processing portion 30 is capable of executing the comparison operation at a speed of more than tens of MHz. Due to the slim design of the parallel arithmetic processing portion 30 it is possible to process a very large number of segments 25 in parallel, whereby extremely high resolution may be achieved at high speed peak detection rates. The resolution (normalized by the length of the photodiode array) may e.g. be better than 1/1000 when the number n of segments 25 are more than one thousand. As explained above, compared to the position detecting element using the conventional PSD or CCD, the position detecting device 10 according to the present invention enables the position to be detected at high speed and high resolution.

Preferably the position detecting device 10 according to the present invention is designed so that it can be produced on one single chip, comprising both the photo detection element array 20 and the parallel arithmetic processing portion 30. One possible way is to use conventional CMOS-technique, whereby both arrays of linear photodiodes and signal processing electronic components can be produced in the same process on the same chip. Due to this design, it is possible to make very large arrays of photodiodes with associated signal processing circuits, whereby the desired resolution readily can be achieved.

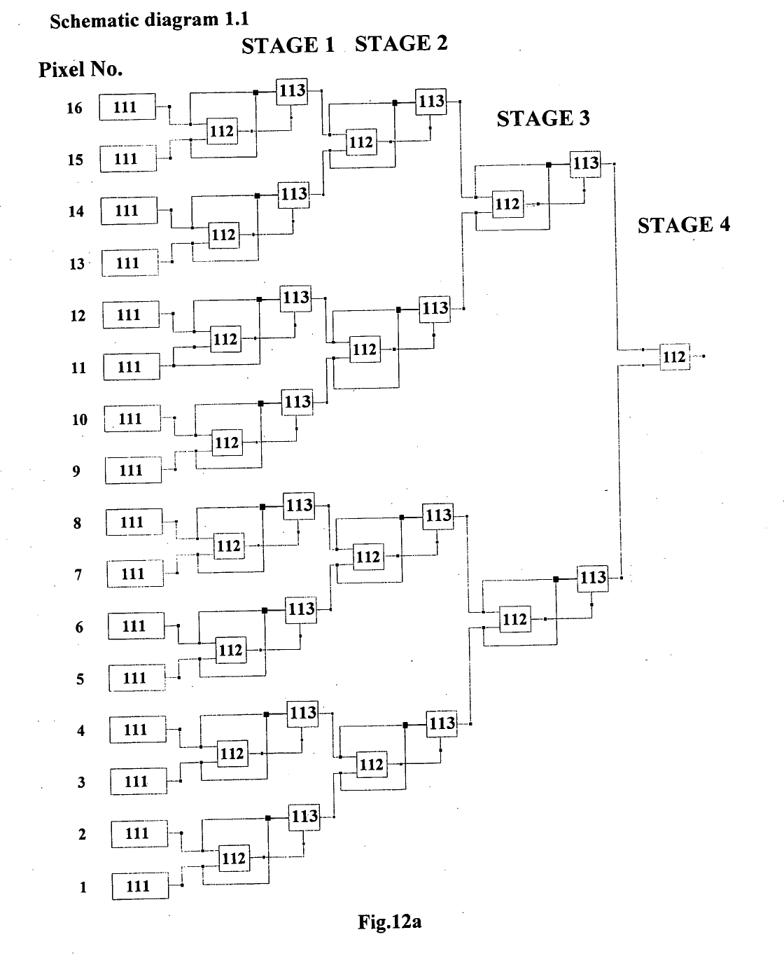

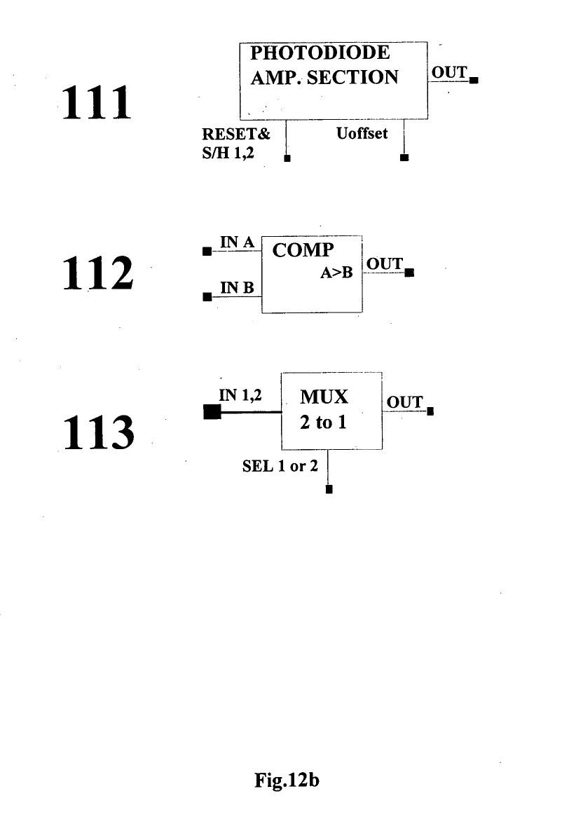

According to one embodiment the parallel arithmetic processing portion 30 comprises at least one pair wise comparing stage 40 that is arranged to pair wise compare the output values OV of selected input segments IS, and for each such pair select the input segment IS with highest output value OV and deselect the input segment IS with lowest output value OV. One possible way to design a parallel arithmetic processing portion 30 based on comparing stages of this type is described in detail as embodiment 1:1 below. According to this embodiment, schematically shown in FIG. 12 each pair wise comparing stage, for each pair of input segment IS, comprises a select circuit comprising one comparator 112 for selecting the input segment IS with the highest output value and one two-channel multiplexer 113 that in response to the comparator 112 provides the output value OV of the selected input segment IS at its output.

As is described more in detail below, the embodiment 1.1 is able to provide the position of the peak segment without any additional logic circuits by providing the outputs from the comparators as a binary signal. It is further able to provide the position of the segment having the smallest value by negating the comparators.

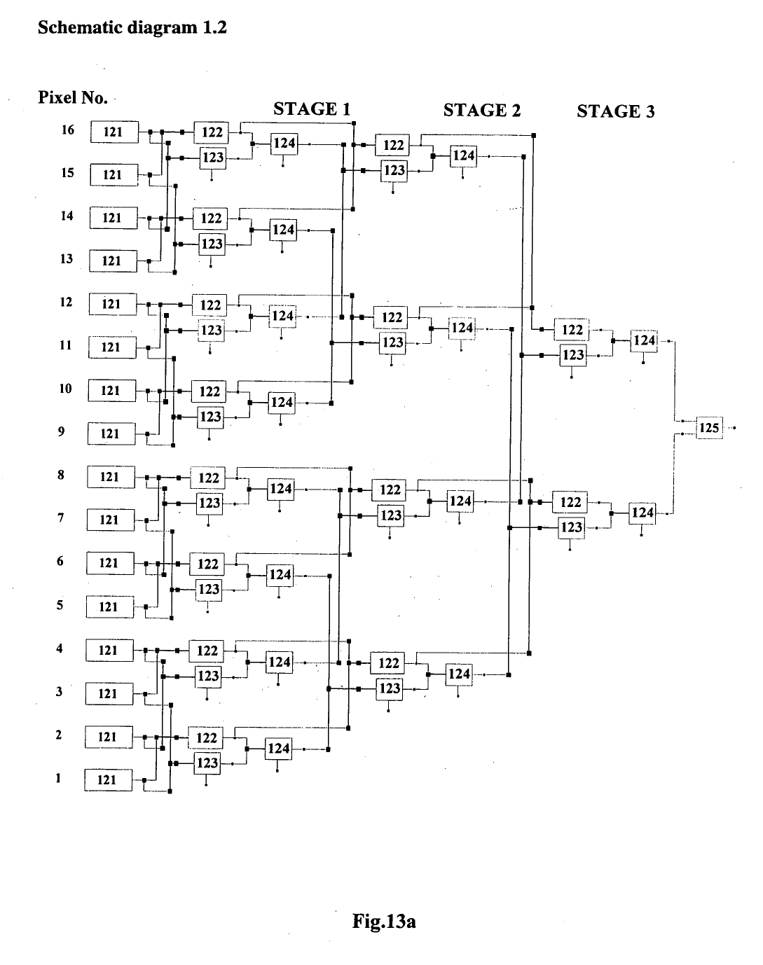

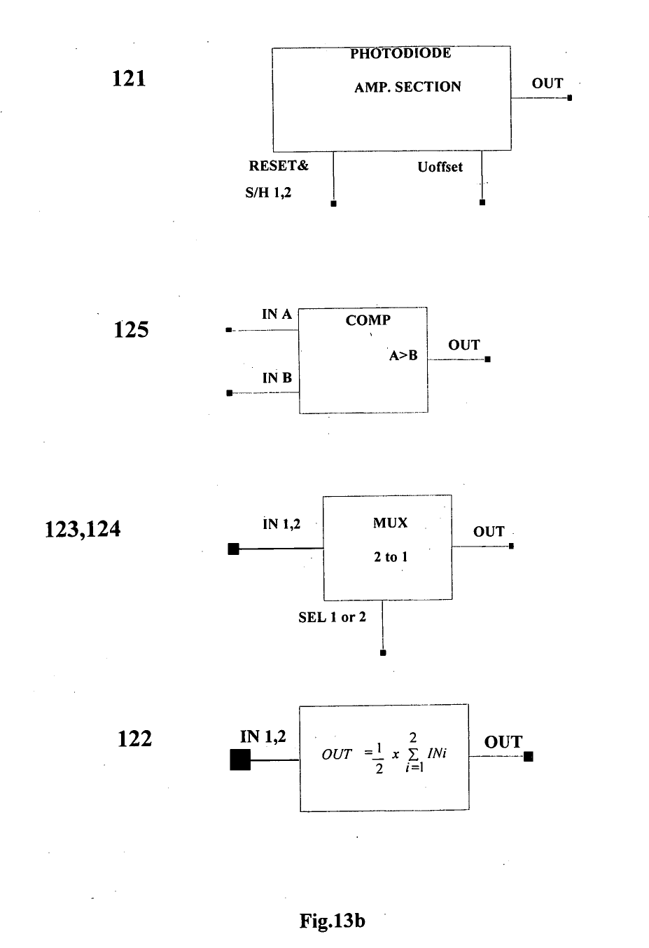

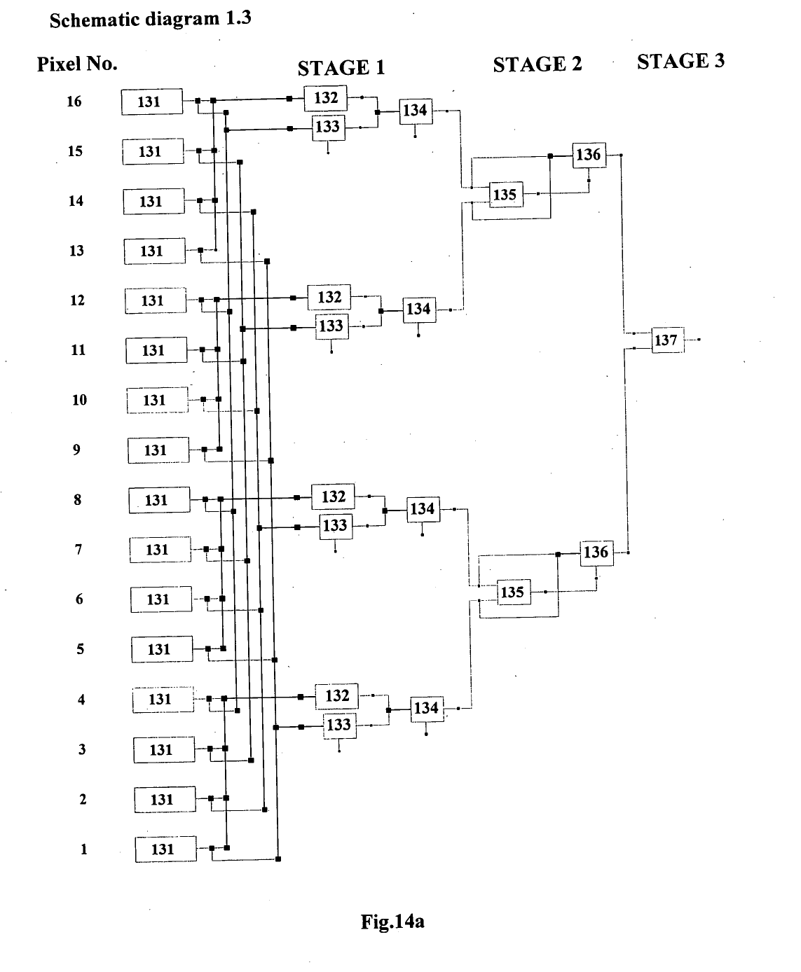

According to one embodiment the parallel arithmetic processing portion 30 comprises at least a first stage 40 in the form of a block comparing stage that is arranged to divide the output values OV from selected input segments IS into at least two blocks, calculate the block average value of the Output values OV for each block, compare the block average values, and select the block with the highest average value. One possible way to design a parallel arithmetic processing portion 30 based on comparing stages of this type is described in detail as embodiment 1:2 below. According to this embodiment, schematically shown in FIG. 13, each block comparing stage comprises a number of select circuits (SC). Each such select circuit comprises a m channel input select multiplexer 123 (ISMₘ), an m channel average circuit

$$( \frac{1}{m} {\sum }_{m}^{1} I S ) 122 ( A V C ) ,$$

and a 2 channel output select multiplexer 124 (OSM). The average circuit 122 receives as input the output value OV from m input segments IS 121 and provides the average of the output values OV from the input segments IS as output. The input select multiplexer 123 receives as input the output value OV from one of the m input segments IS connected to the average circuit 122 in the same select circuit and output values OV from m-1 input segments IS connected to average circuits 122 in other select circuits, and provides the selected one of these as output. The output select multiplexer 124 receives as input the output from the average circuit 122 and the input segment 123, and provides the selected one of these two as output to the next stage.

As can be seen in FIG. 13, if a block comparing stage B is preceded by another block comparing stage A, then each average circuit 122 in stage B is arranged to receive as input the outputs from m average circuits 122 in stage A, while the input select multiplexers 123 in stage B are arranged to receive as input the outputs from one of the m output select multiplexer 124 of the select circuits in stage A connected to the average circuit 122 in the same select circuit in stage B and output values OV from m-1 output select multiplexer 124 of the select circuits SC in stage A connected to average circuits 122 in other average circuits in stage B. This will be described more in detail below, in the detailed description of embodiment 1.2.

Compared to embodiment 1.1, the embodiment 1.2 is based on a simpler circuitry but instead it requires external logic routines to control the successive settings of the multiplexers. Embodiments 1.3 and 1.4 below are examples of possible combinations/alternations of the different comparing stages presented in the above embodiments. More specifically embodiment 1.4 comprises at least two block comparing stages that compares the same set of input segment IS but divided into blocks overlapping the block edges in the other stage, so that a peak output value OV located close to a block edge in one stage is not located close to a block edge in the other stage, whereby the average output values OV for that block will be higher than from all other blocks, said block is selected.

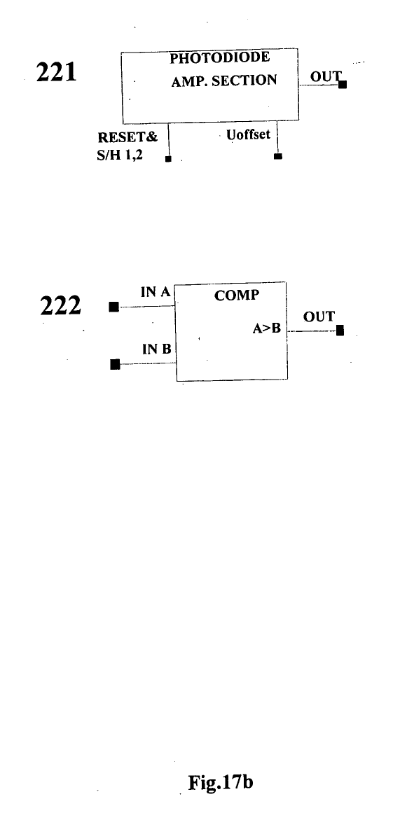

According to still another embodiment, the parallel arithmetic processing portion 30 comprises a threshold comparing stage arranged to compare the output values OV from all selected input segments IS with a threshold value and deselect all input segments IS having an output value OV lower than the threshold value until only one output value OV remains higher than the threshold. One possible way to design a parallel arithmetic processing portion 30 based on one single comparing stage of this type is described in detail as embodiment 2.2 below. According to this embodiment, which is schematically shown in FIG. 17, each segment 221 of the photo detection element array 20 is connected to one of the inputs of a comparator 222, while the other input is connected to a successive approximation sequencer 223 arranged to provide a threshold signal to the comparators 222 and to register the output from the comparators 222. The sequencer 223 performs an iterative altering of the threshold value until only one comparator 222 indicates that the corresponding input segment IS is higher than the threshold value.

Embodiments performing consecutive average and discrimination are all based on iterative searching for the largest signal value in the ensemble of signal values after a sampling interval is finished. In an alternative embodiment the input segment IS comprises an integrator with or without and superseding “Sample and Hold Circuit”. This segment is connected to a comparator stage and an one way of finding the maximum value is to set the threshold signal/voltage on the comparator to a value very close to the maximum value allowed in the circuit. In this way, when all the input segments are integrating up their signals then the one that first reaches this threshold value will stop the whole sampling/integration cycle for all others. If no one of the photodiode circuits reaches this threshold during the integration/sampling interval then do we just fall back on the iterative embodiments of above.

The position detecting device 10 according to the present invention is primary directed to be used in a triangulating rangefinder, but it could obviously be used in any other application where position detection at high speed and high precision is desired.

### Embodiments Overview

General

Definitions

Nₚᵢₓₑₗ=number of pixels, normally is this number chosen to be a multiple of 2.
This means that Nₚᵢₓₑₗ=2^{k}. In the descriptions and figures are k chosen to be 4, for simplicity and “easy” to understand figures. However it is possible to let k be any number by simple adjustments of the circuit lay-out.
For each pixel is there a photodiode amplifier.
Hereafter called PDA.
Sᵢ=the output signal from the i:th PDA-cell
The PDA circuit can have provisions for an individual or a global offset and/or gain correction and/or Correlated Double Sampling

Compare 2 by 2

General Description

The methodologies outlined below all rely on iterative comparing of signals two by two. In some cases is the signals clustered into bins and the average of the bin signals are taken, then is the 2 by 2 comparison network used to in an iterative manner find the largest bin average and in the last iteration find the PDA with the largest signal/value.

### Embodiment 1.1 Successive Compare 2 by 2

Description

One example of a circuit design is shown in FIG. 12.

For a 16 pixels linear array demands this methodology comprises 4 stages of comparators and 2 to 1 multiplexers.

Stage/step 1: The PDA's 111 are connected in a 2 by 2 fashion to comparators 112 and 2 to 1 multiplexers 113. This gives 8 comparators/multiplexers in the first stage.

Stage/step 2: In the second stage are there 4 comparators/2 to 1 multiplexers connected to the outputs to the preceding stage multiplexers.

Stage/step 3: In the third stage are there 2 comparators/2 to 1 multiplexers connected to the outputs to the preceding stage multiplexers.

Stage/step 4: In the fourth stage are there 1 comparators/2 to 1 multiplexers connected to the outputs to the preceding stage multiplexers.

This gives a total of 8+4+2+1=15 comparators/2 to 1 multiplexers.

Methodology

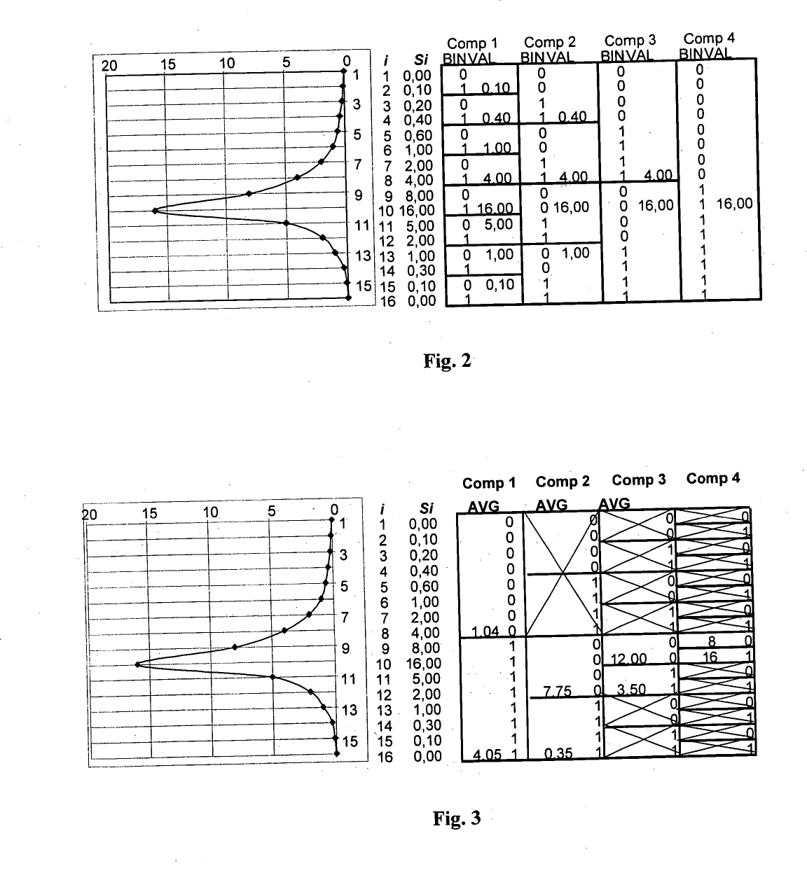

FIG. 2 shows a diagram that illustrates the operation of this embodiment.

First in Stage/step 1 are all 16 PDA signals compared 2 by 2, the largest signal from each comparison is fed forward trough the 2 to 1 multiplexer to Stage/step 2.

Then in Stage/step 2 are the 8 largest signals from the preceding stage compared 2 by 2, the largest signal from each comparison is fed forward trough the 2 to 1 multiplexer to Stage/step 3.

Then in Stage/step 3 are the 4 largest signals from the preceding stage compared 2 by 2, the largest signal from each comparison is fed forward trough the 2 to 1 multiplexer to Stage/step 4.

Then in Stage/step 4 are the 2 largest signals from the preceding stage compared 2 by 2, the largest signal from the comparison is fed forward trough the 2 to 1 multiplexer. This is the largest signal/value from the 16 PDA's.

Decoding which PDA that holds the largest signal/value is just a decoding of the comparator outputs state beginning from the last comparator going backward. The comparators outputs give a direct binary representation of the PDA number. Negating the comparator outputs gives the results in finding the PDA having the smallest signal/value. A linear array having 1024 pixels you will need 10 Stages/steps with 512+256+128+64+32+16+8+4+2+1=1023 comparators/2 to 1 multiplexers.

### Embodiment 1.2 Successive Compare 2 by 2 with Bin Average Size Divide by 2

Description

One example of a circuit design is shown in FIG. 13.

This method is designed to minimize the amount of comparators and uses only one.

For a 16 pixels linear array demands this methodology 3 stages of averaging and two 2 to 1 multiplexers and a fourth stage containing a comparator. The average circuit takes the average of two signals, this means that

$$OUT = \frac{{S}_{i} + {S}_{i + 1}}{2}$$

Stage/step 1: The PDA's 121 are connected in a 2 by 2 fashion to a average circuit 122 and one 2 to 1 multiplexer 123. To the average circuit and to the first 2 to 1 multiplexer is another 2 to 1 multiplexer 124 connected. This gives 8 average/multiplexers in the first stage.
Stage/step 2: In the second stage there are 4 average/two 2 to 1 multiplexers connected to the outputs to the preceding stage multiplexers.
Stage/step 3: In the third stage there are 2 average/two 2 to 1 multiplexers connected to the outputs to the preceding stage multiplexers.
Stage/step 4: In the fourth stage there is one comparator 125 connected to the outputs to the preceding stage of multiplexers.

This gives a total of 8+4+2=14 average/two 2 to 1 multiplexers+one comparator.

Methodology

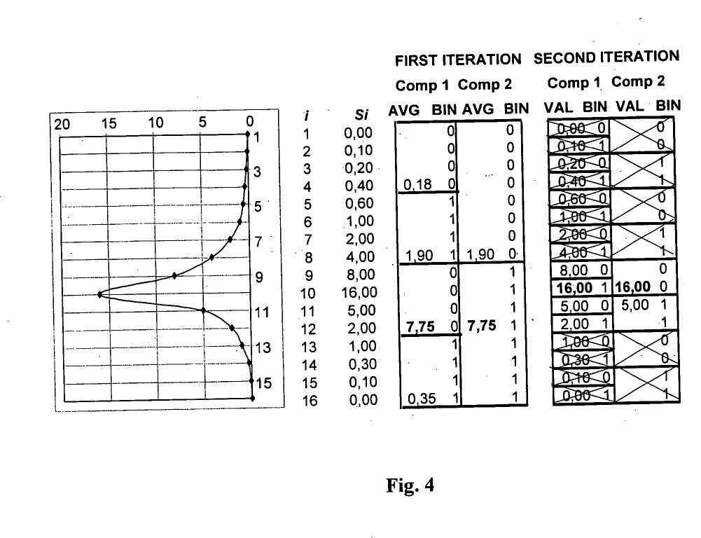

FIG. 3 shows a diagram that illustrates the operation of this embodiment.

For a 16 pixel array is the methodology as follows and relies on that only one comparator is used to decide which half is the greatest in several iterations. For a 16 pixel array will there be four iterations.
First iteration: To the single comparator are the two averages,

$$A = \frac{1}{8} * ( {S}_{1} + {S}_{2} + … + {S}_{8} ) \\ and \\ B = \frac{1}{8} * ( {S}_{9} + {S}_{10} + … + {S}_{16} )$$

connected and we use the comparator to decide which average is the greatest. This is obtained by setting all the 2 to 1 multiplexers 124 in such a state that all the averages from the average circuit 122 is connected to the comparator 125.
Second iteration: The largest average from first iteration is divided into two halves containing four signal/values each and another comparison is made.
Third iteration: The largest average from second iteration is divided into two halves containing two signal/values each and another comparison is made.
Fourth iteration: The largest average from third iteration is divided into two halves containing one signal/values each and another comparison is made. This is the last iteration were we compare two single signals.

Decoding which PDA that holds the largest signal/value is just a decoding of the comparator output state in each iteration beginning from the first iteration going forward to the fourth iteration. The comparators output state in each iteration gives direct a binary representation of the PDA number which holds the signal with the greatest signal/value. Negating the comparator outputs gives the results in finding the PDA having the smallest signal/value. A linear array having 1024 pixels you will need 9 Stages/steps with 512+256+128+64+32+16+8+4+2=1022 average circuits and two 2 to 1 multiplexers and one comparator.

Embodiment 1.3 Successive Compare 2 by 2 with Bin Size=\sqrt{Nₚᵢₓₑₗ}

Description

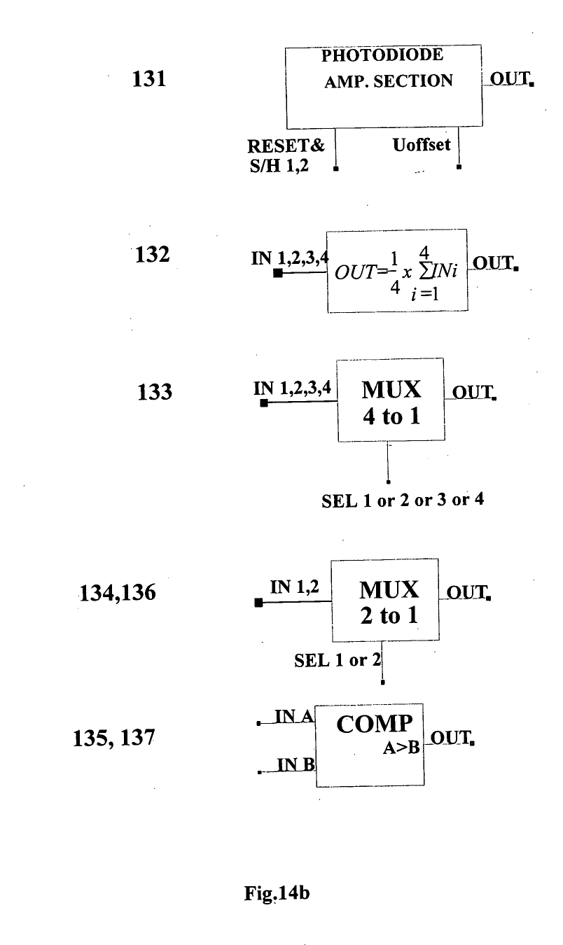

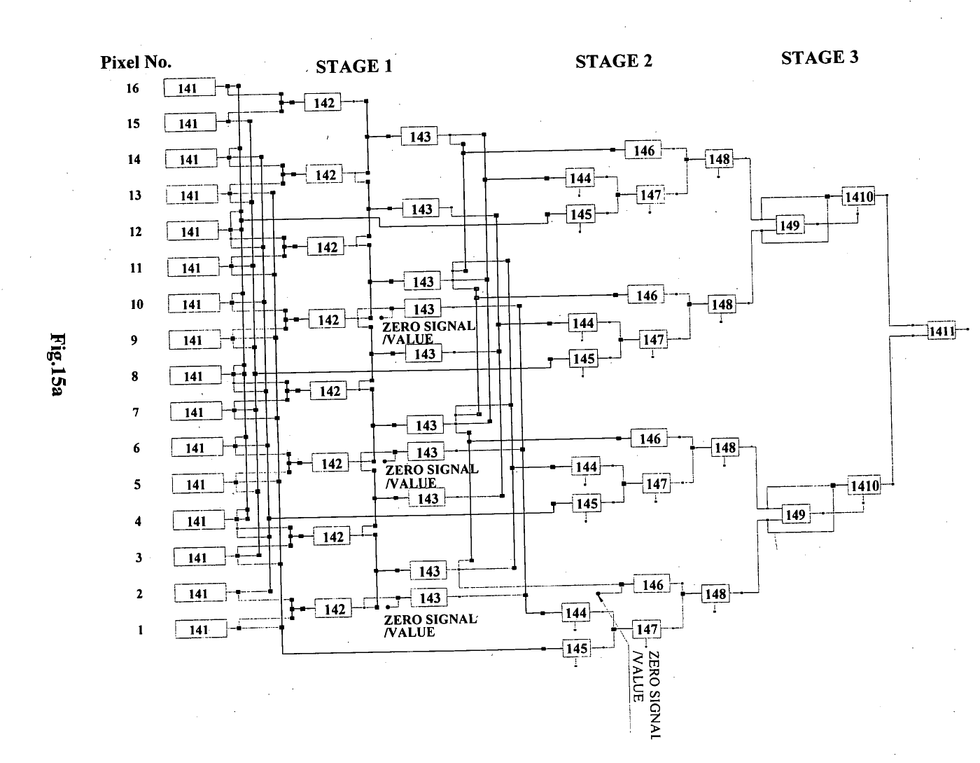

One example of a circuit design is shown in FIG. 14.

This methodology uses a good mixture of comparators/average circuits and multiplexers. This methodology is a mixture of 1.1 and 1.2 and can be described as you are doing a 2 by 2 comparison in two steps in two iteration steps.

The 16 signals from the PDA's 131 has been grouped into four average signals/values 132,

$$\begin{matrix}{A}_{1} = \frac{1}{4} * ( {S}_{1} + … + {S}_{4} ) , \\ {A}_{2} = \frac{1}{4} * ( {S}_{5} + … + {S}_{8} ) , \\ {A}_{3} = \frac{1}{4} * ( {S}_{9} + … + {S}_{12} ) \\ and \\ {A}_{4} = \frac{1}{4} * ( {S}_{13} + … + {S}_{16} ) .\end{matrix}$$

To the 16 PDA's are also four 4 to 1 multiplexers 133 connected in following manner. To the first multiplexer PDA signals 1, 5, 9, 13 to the second 2, 6, 10, 14 to the third 3, 7, 11, 15 to the fourth 4, 8, 12, 16.

A 2 to 1 multiplexer 134 is connected to the average circuit and the 4 to 1 multiplexer.

A two stage net of 3 comparators 135, 137 with 2 to 1 multiplexers 136 are connected to these four signals.

Stage/step 1: The four 2 to 1 multiplexers 134 are connected in a 2 by 2 fashion to a comparator 135 and a 2 to 1 multiplexer 136. This gives 2 comparators/multiplexers in the first stage.

Stage/step 2: In the second stage one comparator is connected to the outputs to the preceding stage multiplexers 136.

The above described net is used in two iterations. The comparison stage comprises 2+1=3 comparators and two 2 to 1 multiplexers. The average and select stage consists of four average-, 4 to 1 and 2 to 1 multiplexers.

Methodology

FIG. 4 shows a diagram that illustrates the operation of this embodiment.

First Iteration:

First in Stage/step 1 all four average signals are compared 2 by 2, the largest signal from each comparison is fed forward trough the 2 to 1 multiplexer to Stage/step 2.

Then in Stage/step 2 the two largest signals from the preceding stage are compared 2 by 2.

The first iteration has by this decided which bin average of the four that was the greatest.

Second Iteration:

Then in Stage/step 1 the 4 signals from the largest signals from the preceding stage are compared 2 by 2, the largest signal from each comparison is fed forward trough the 2 to 1 multiplexer 134 to Stage/step 2.

Then in Stage/step 2 the 2 largest signals from the preceding stage are compared 2 by 2, the largest signal from this comparison is the largest signal/value from the 16 PDA's.

Decoding which PDA that holds the largest signal/value is just a decoding of the comparator outputs state beginning from the last comparator going backward. The comparator outputs give a direct binary representation of the PD number. Negating the comparator outputs gives the results in finding the PD having the smallest signal/value. A linear array having 1024 pixels you will need 10 Stages/steps with 512+256+128+64+32+16+8+4+2+1=1023 comparators/2 to 1 multiplexers.

### Embodiment 1.4 Compare 2 by 2 with Overlapping Bins

Description

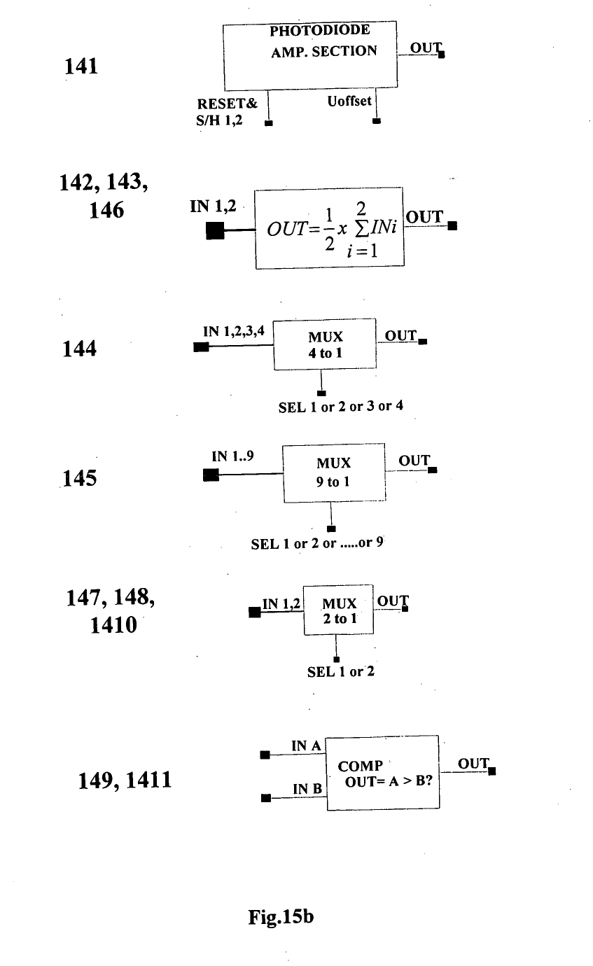

One example of a circuit design is shown in FIG. 15.

One way to create overlapping bins is according to following method. BIN 1=S₁ to S₈, BIN 3=S₉to S₁₆, BIN 2=S₄ to S₁₂

The “problem” is that the bin consists of 8 signals and a 2 by 2 comparison network used in two iterations will not be efficiently used in this bin configuration. In an efficient set-up does the number of bins equal the number of PDA signals in the bin. This conclusion leads to that for a 16 signal/pixels array that we shall apply the method outlined below which shortly can be described as instead of making the 2 by 2 comparison in two steps we do it in three.

With reference to FIG. 15 this solution consist of 16 PDA's 141, two stages of average by two circuits 142, 143. The average circuits are used to generate overlapping average by four signals. After the average circuits comes a circuit cluster that consists of one 4 to 1 multiplexer 144, one 9 to 1 multiplexer 145, thereafter another 2 to 1 multiplexer 147, in parallel with this multiplexer is a average by two circuit 146 and these two circuits are connected to a 2 to 1 multiplexer 148. There are four 2 to 1 multiplexers 148 which are connected to a four signal compare 2 by 2 network that consists of three comparators 149, 1411 and two 2 to 1 multiplexers 1410.

Methodology

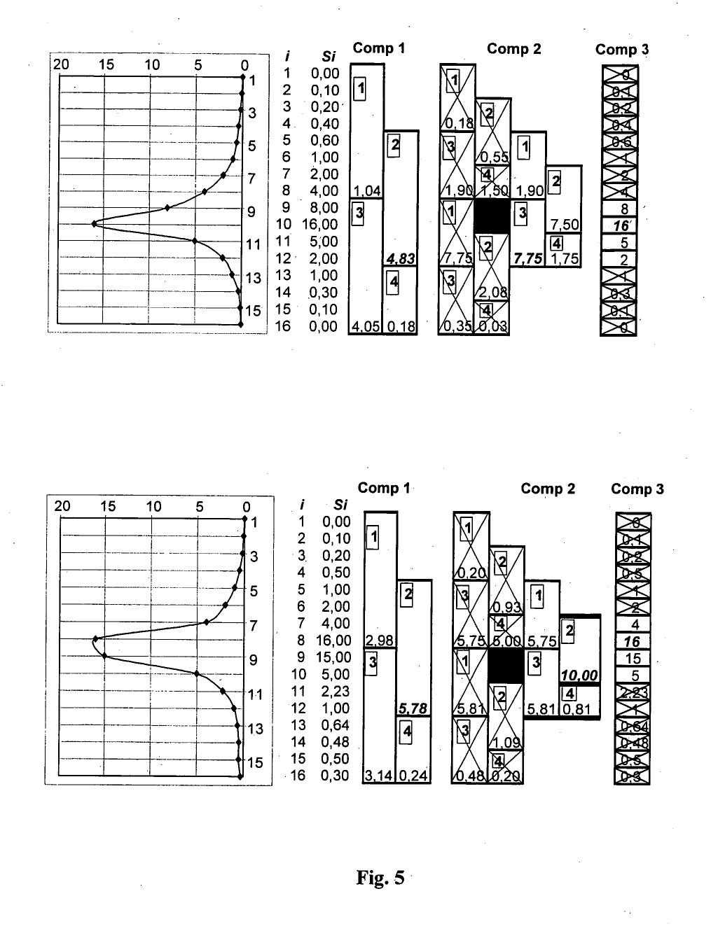

FIG. 5 shows two diagrams that illustrate the operation of this embodiment.

Comparison 1:

For the first comparison the multiplexers 148 are in such a position and connected to the average circuits 146 that we compare the averages from four overlapping bins, BIN 1=S₁ to S₈, BIN 3=S₉ to S₁₆, BIN 2=S₄ to S₁₂ and BIN 4=S₁₃ to S₁₆. Were we use the comparison network to find the biggest of the four bin averages, were BIN 4=S₁₃ to S₁₆ is divided by 8 in order to ensure that it is not bigger than anyone of the other three averages.

Comparison 2:

In the second comparison are the two 2 to 1 multiplexers 147, 148 controlled so that the 4 to 1 multiplexer 144 is connected to the compare 2 by 2 network. The 4 to 1 multiplexers 144 are set in such a position that the bin with the largest average from Comparison 1 is now divided into four smaller and overlapping bins. The meaning of this is easiest to show if we take a look in the signal curve figure (FIG. 5) were for both curves the BIN 2 average was found to be the largest in Comparison 1. As can be seen from this figure BIN 2 is divided into four new smaller Bin's and their respective divide by 4 averages. This gives that we have four new signals connected to the compare 2 by 2 network which we use to find the largest bin average. From the signal curve figure do we see that this was BIN 3 for the top curve and BIN 2 for the bottom curve.

Comparison 3:

In the third comparison do we control the multiplexers 147, 148 so the comparison network is connected to the 9 to 1 multiplexers 145. Then we use the results from Comparison 2 to control multiplexers 145 so that the four PDA's/pixels signals that formed the largest bin average in Comparison 2 are connected to the compare 2 by 2 network. From the signal curve figure do we see that last comparison gives that pixel/PDA signal 10 and 8 are found to be largest for the top and bottom curve respectively.

This can be condensed into following formula when using even PDA's signals in a bin:

Nₚᵢₓₑₗₛ=Number of pixels

N_{BIN}=Number of bins

Number of overlapping bins and pixels in the last bin=2×N_{BIN}

k=Number of iterations

this gives that
(2×N_{BIN})×N_{BIN}^{k}=Nₚᵢₓₑₗ
Assume that Nₚᵢₓₑₗ=16 this gives that
2×N_{BIN}^{k+1}=16=2⁴N_{BIN}^{k+1}=2³k+1=3k=2
Same formula applied to a 1024 array ends with two different results.
2×N_{BIN}^{k+1}=1024=2¹⁰N_{BIN}^{k+1}=2⁹=2^{3×3}=8³ this gives:
N_{BIN}^{k+1}=2⁹k+1=9k=8 and N_{BIN}=2 1.
N_{BIN}^{k+1}8³k+1=3k=2 and N_{BIN}=8 2.

Another choice for optimizing the circuit topology is to choose the number of pixels in the last bin to be odd. This circuit topology will NOT optimize any decide methodology because it is NOT a function of power of two although it will minimize the number of average circuits.

For such a topology will the formulas look as follows:

Nₚᵢₓₑₗ=Number of pixels

N_{BIN}=Number of bins

Number of overlapping bins and pixels in the last bin=2×N_{BIN}−1

k=Number of iterations

this gives that
(2×N_{BIN}−1)×N_{BIN}^{k}=Nₚᵢₓₑₗ
assume N_{BIN}=2 [symbol] 3×2^{k}=Nₚᵢₓₑₗ
2 Level Threshold
General Description

The methodologies described in this section are based on that you in an iteratively manner calculates an average of all signals after a threshold and discrimination has been applied to the signals, this average is hereafter called Sₖ m̅ₖ̅ where k stands for the k:th iteration. The average/threshold is compared one by one with every signal Sⱼ were j is the j:th signal value. If the signal value is greater than the average then the output from a discrimination circuit is set to be Sⱼ else 0. This can be expressed as

IF Sⱼ> m̅ₖ̅ THEN

OutSi=Sⱼ
   ELSE
OutSi=0

From these discriminated signals a new average is calculated. The average calculation can in a more formal way be described as follows:

m̅ₖ̅=sum(OutSi)/N were OutSi=Si if Si> m̅ₖ̅₋̅₁̅else is OutSi=0;

N=Number of Si≠0.

### Embodiment 2.1 Ramp Generator

Description

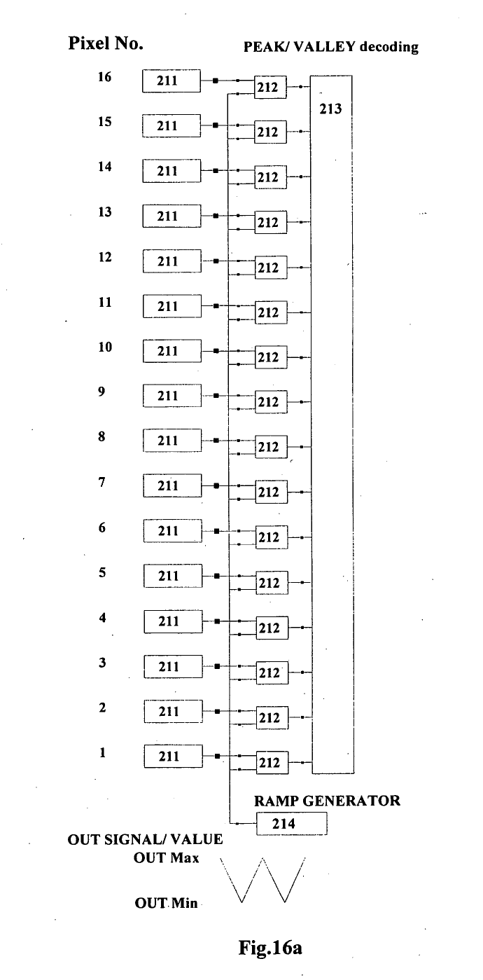

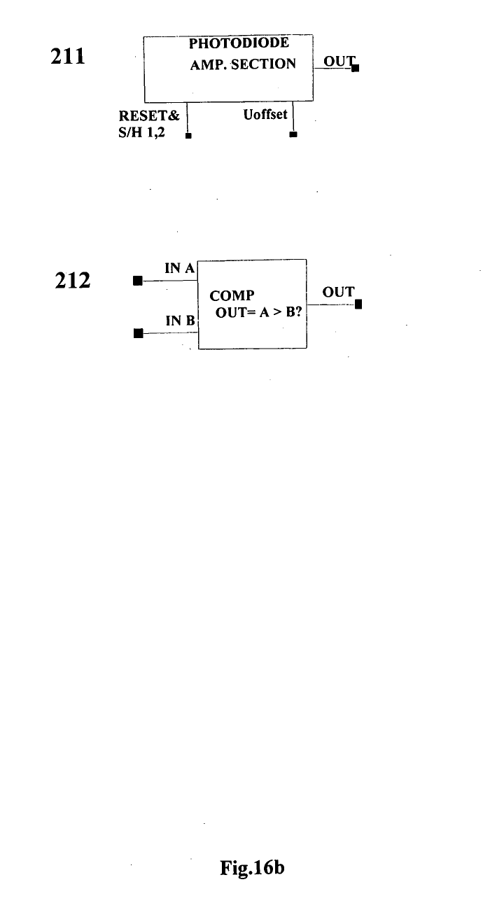

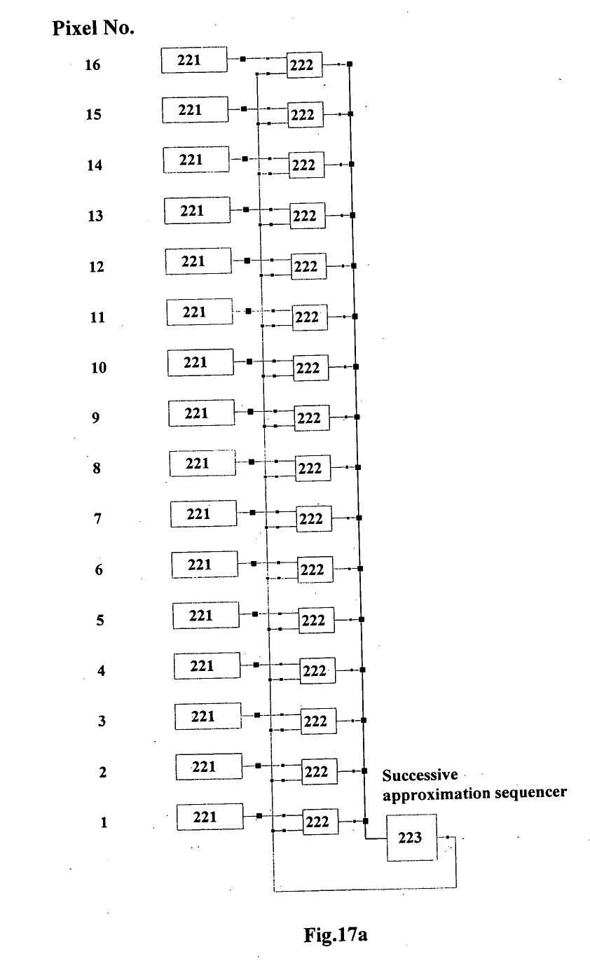

One example of a circuit design is shown in FIG. 16.

To each PDA/pixel 211a comparator 212 is connected, to the other input of these comparators a signal/value generator 214 is connected. The outputs of the comparators are connected to a logical circuit 213 that detects the peak- and valley signal values.

Methodology

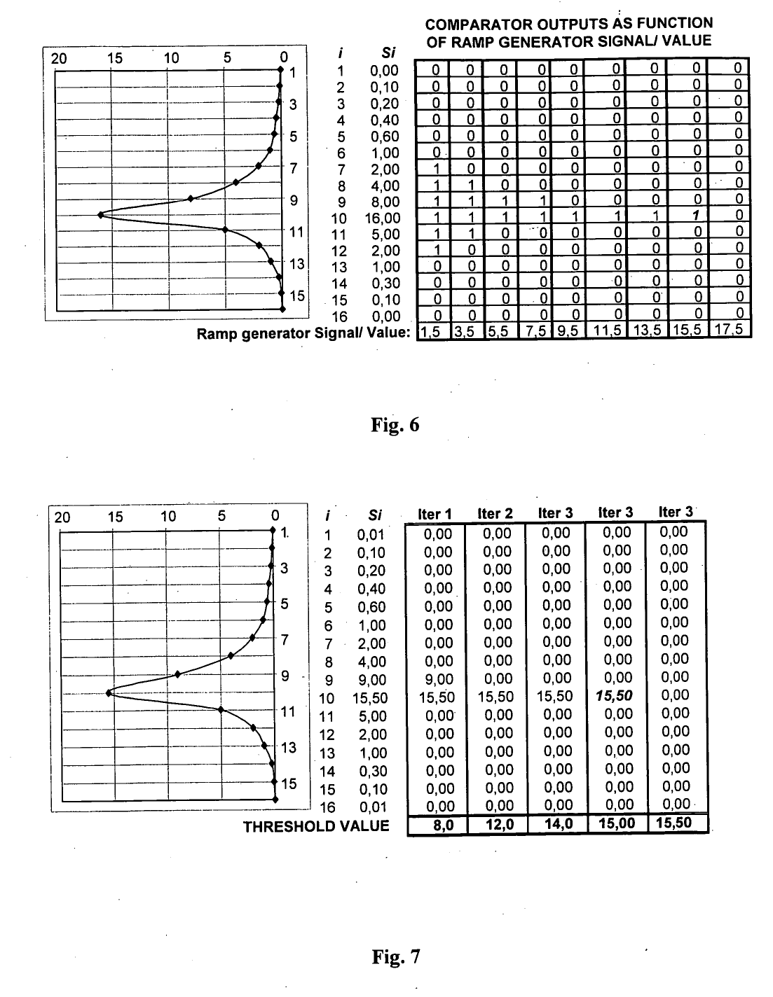

FIG. 6 shows a diagram that illustrates the operation of this embodiment.

The value/signal generator 214 generates a saw tooth shaped signal/set of values as function of time. The signal/value goes from the lowest possible value to the highest possible value from the PDA's. The logic circuit 213 decodes the pixels which have the highest and/or the lowest signal/values. This particular embodiment is to be as considered prior art, but is included here because some of the embodiments later on will incorporate more intelligent methodologies to find the pixels with the greatest/smallest signals/values.

### Embodiment 2.2 Successive Approximation Threshold

Description

One example of a circuit design is shown in FIG. 17.

A comparator 222 is connected to each PDA/pixel 221, an approximation sequencer circuit 223 is connected to the other input of the comparators. The outputs of the comparators are connected to an input terminal of the successive approximation sequencer circuit 223 that detects if there were any signals which were greater than the last applied threshold value. The approximation sequencer circuit 223 deducts a new threshold value which it imposes on the comparators.

Methodology

FIG. 7 shows a diagram that illustrates the operation of this embodiment.

Please look in the signal curve figure to get an overview of how the methodology works. The output from the approximation sequencer circuit 223 generates a set of values were the signal/value goes from the lowest possible value to the highest possible value from the PDA's. This signal range is hereafter called Urange

Iteration 1.

The first iteration starts in that a threshold voltage that equals 0.5×Urange is applied. Then the approximation sequencer circuit 223 detects if there was any signal that was greater than the threshold.

If YES then it calculates a new threshold that is old threshold +Urange/4 otherwise it calculates a new threshold that is old threshold −Urange/4

Iteration 2.

Second iteration starts in that the new threshold value calculated in Iteration 1 is applied. Then the approximation sequencer circuit 223 detects if there was any signal that was greater than the threshold.

If YES then it calculates a new threshold that is old threshold +Urange/8 otherwise it calculates a new threshold that is old threshold −Urange/8

Iteration 3.

Second iteration starts in that the new threshold value calculated in Iteration 2 is applied. Then the approximation sequencer circuit 223 detects if there was any signal that was greater than the threshold.

If YES then it calculates a new threshold that is old threshold +Urange/16 otherwise it calculates a new threshold that is old threshold −Urange/16

The iteration process is dependent on how many steps that are implemented but for an 8-step solution that gives a resolution of 1/256. ½, ¼, ⅛. . . 1/256

### Embodiment 2.3 Successive Averaging and Threshold

Description

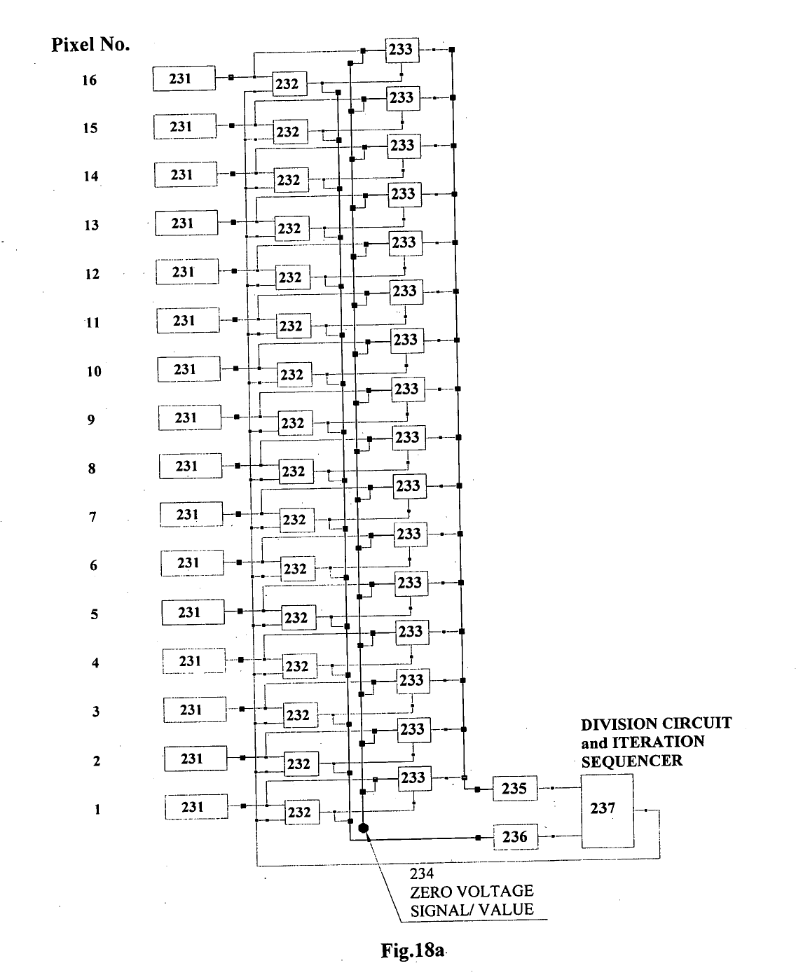

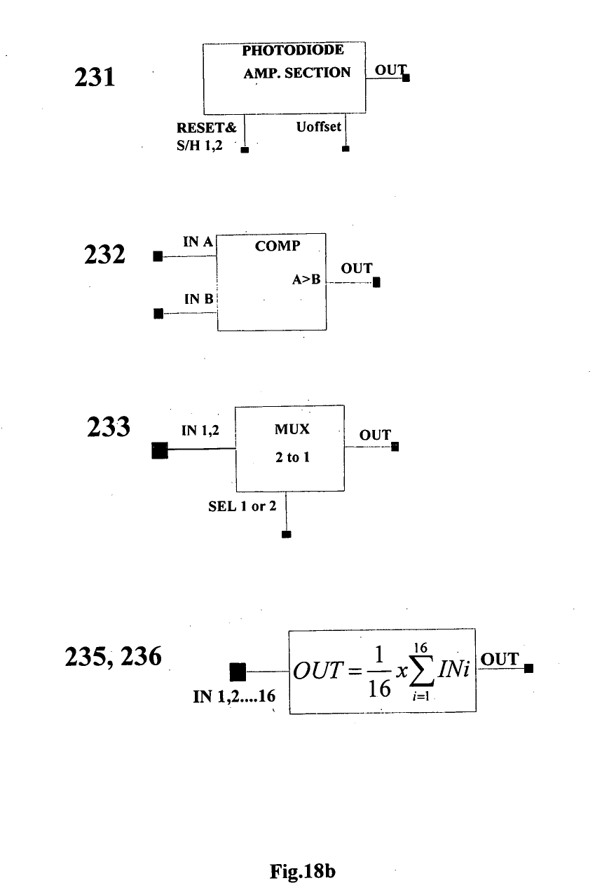

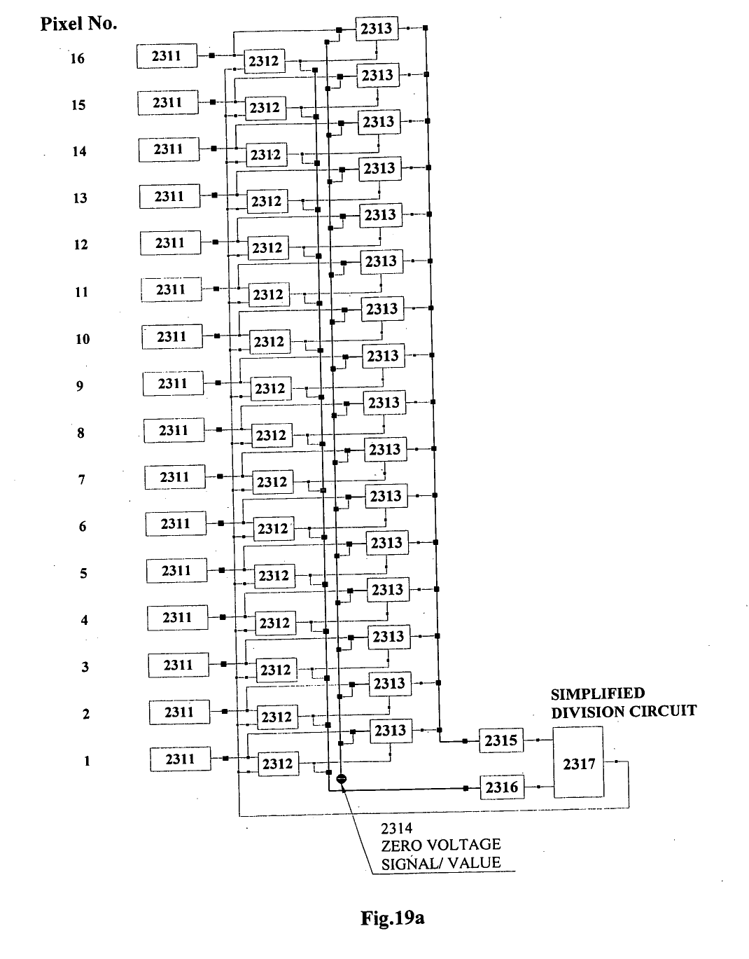

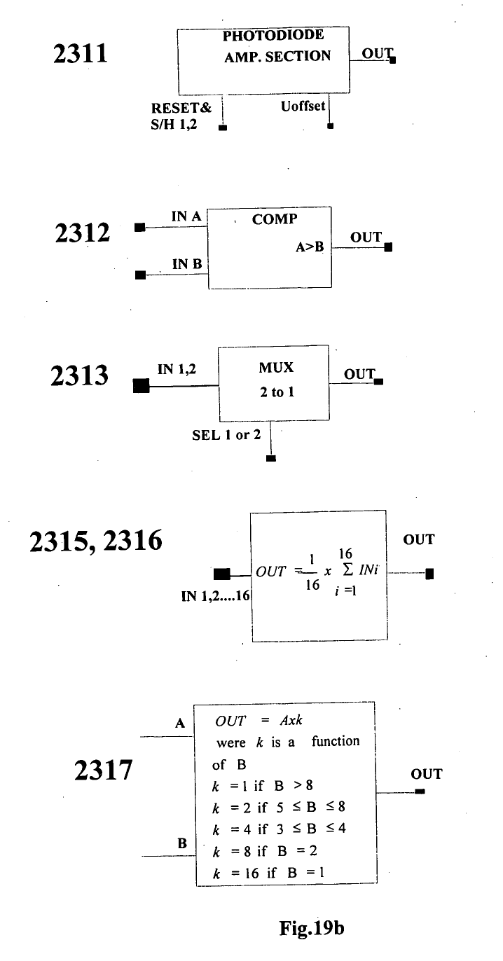

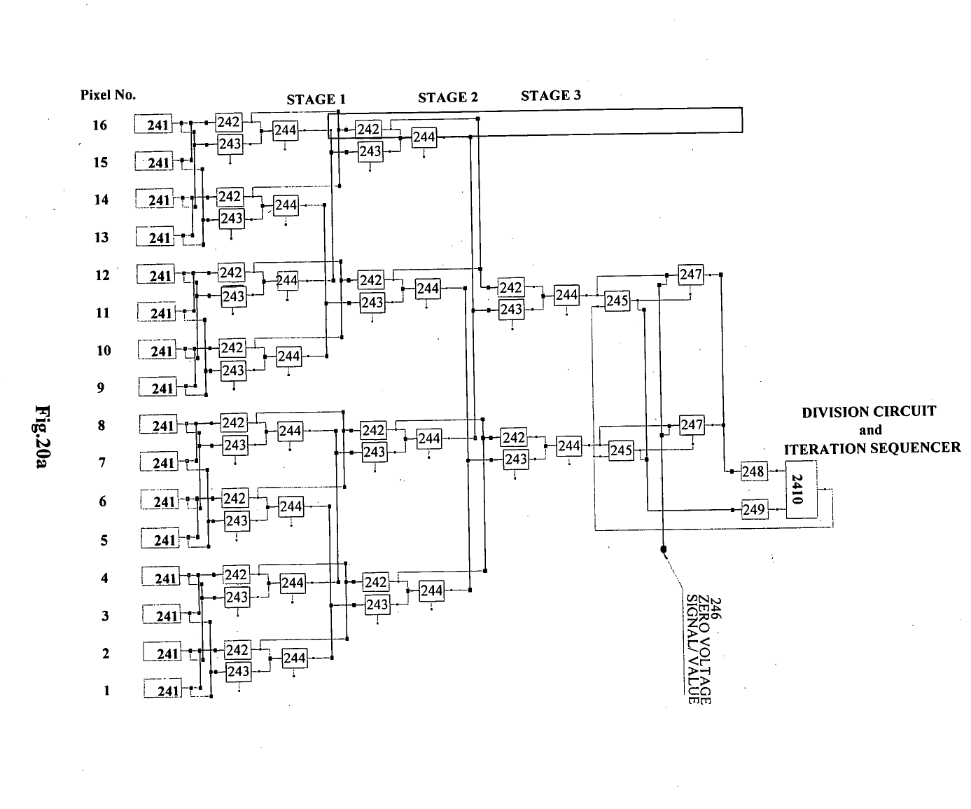

Examples of circuit designs are shown in FIGS. 18 and 19.

There is one comparator 232 for each pixel which has one of its inputs connected to the PDA/pixel 231 signal/value. On the other input is a signal/value generator connected. The output from the comparator 232 is controlling a 2 to 1 multiplexer 233. To the two inputs of the 2 to 1 multiplexer 233 are two signals/values connected. One of the signals is the PDA signal from the PDA at the comparator input. The other is a signal/value which is zero, 0 234 Further there are two average by 16 circuits 235, 236,

$$OUT = \frac{1}{16} {\sum }_{i = 1}^{16} IN i .$$

The average circuit 235 takes the average of the signal/values from the 2 to 1 multiplexers 233. The other average circuit 236 takes the average of the comparator signal outputs, which can be zero, 0 or one, 1. The two average signals are then fed to the division and iteration sequencer circuit 237.

Methodology

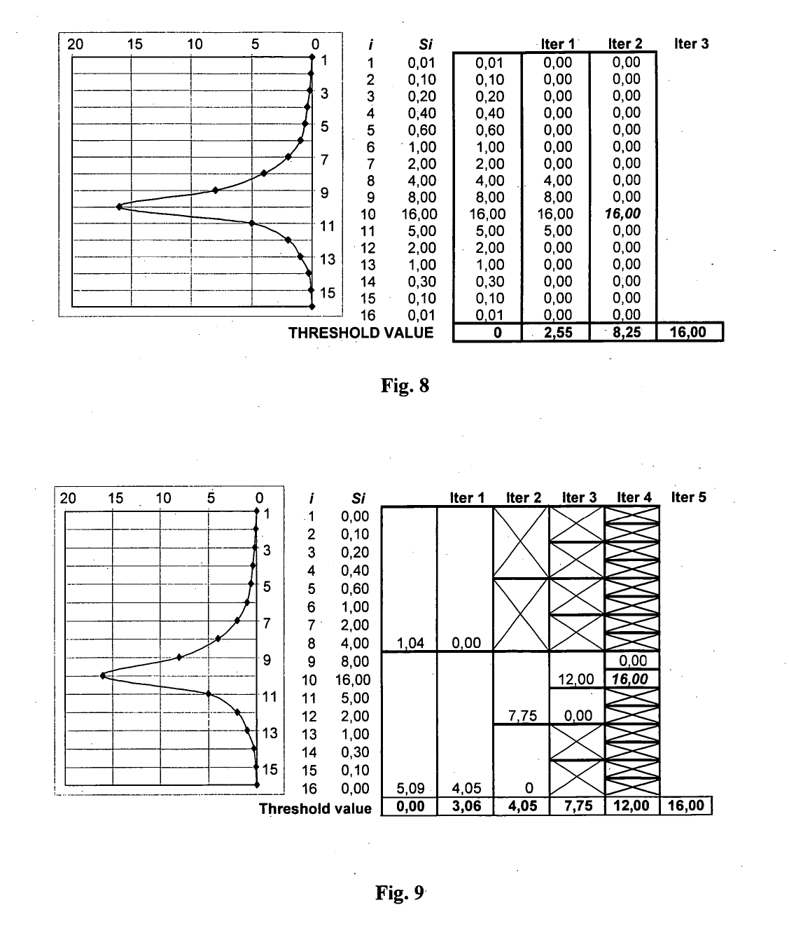

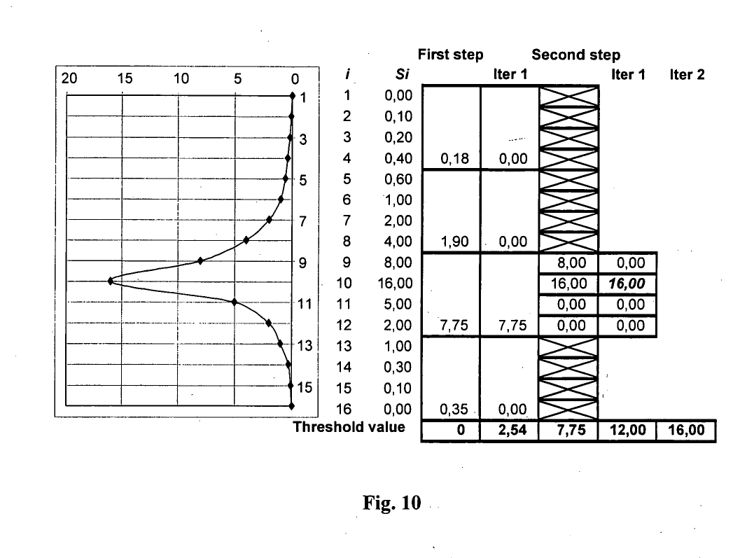

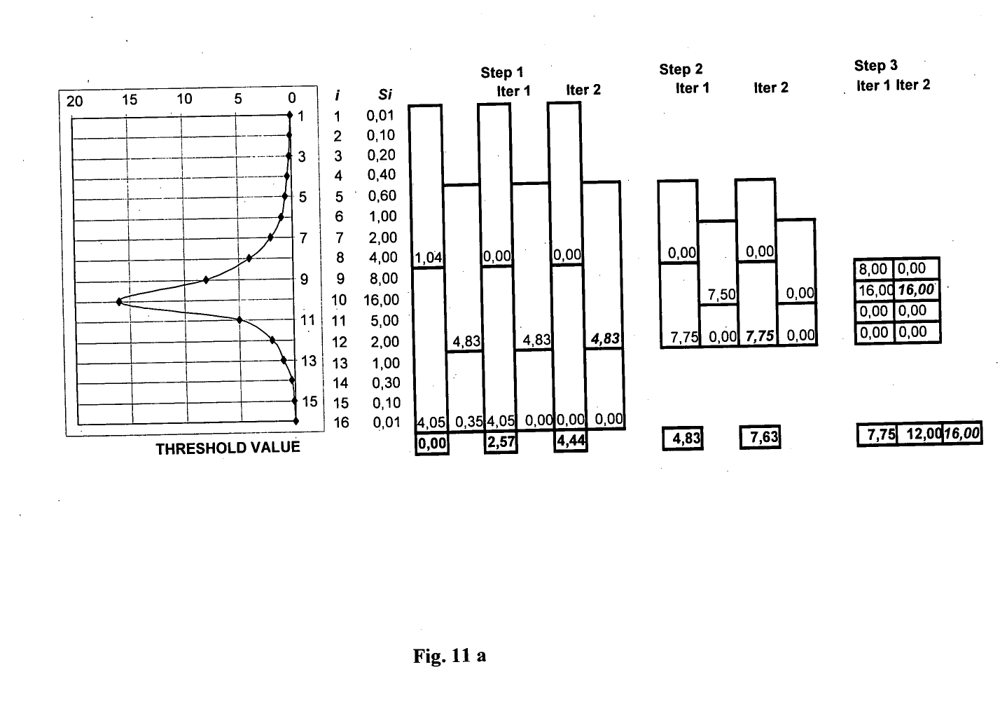

FIG. 8 shows a diagram that illustrate the operation of this embodiment.

Please look at the signal figure during the methodology description.

This is an iterative methodology that goes as follows: Iteration 1.

In the first iteration the output from the division- and iteration sequence circuit 237 is 0 or zero. If we assume that all PDA signals are greater than zero, 0. This gives then that all comparator outputs are one, 1 and that the signals/values from the 2 to 1 multiplexers 233 equals the PDA signals/values. After this does the circuit 237 read the two average values from 235, 236 and calculates the grand average. This average value is then fed to comparator circuits.

Iteration 2

In the second iteration is the average from the preceding iteration fed to the comparators. The result of this is that all comparators that have a PDA signal that is smaller than the average signal gets an zero, 0 at its outputs. The comparators with PDA signals/values that is greater gets an one, 1. This also gives that the outputs from the 2 to 1 multiplexers 233 equals zero, 0 for all comparators were the PDA signal/value was smaller than the average signal/value and equals the PDA signal/value for all comparators were the PDA signal/value was greater than the Average signal from the division and iteration sequencer circuit 237. From these new comparator and 2 to 1 multiplexer signals can we calculate two new average signals in the average circuits 235, 236. These two new average signals are fed to the division and iteration sequence circuit 237 to calculate a new grand average. This average is larger than the average calculated in Iteration 1 because it contains only signals greater than the average calculated in Iteration 1. This new average signal is fed to the comparators.

Iteration 3.

Same procedure is repeated. Only the signals greater than the average is used to calculate a new average.

The procedure is repeated until there is only the maximum signal value left.

This is normally reached within very few iterations as can be seen in the signal curve FIGS. 18 and 19. This method relies on that we make a division. In order to make any hardware implementation simpler we want to avoid division with an arbitrary integer. This can be avoided if we count the number of comparator signals and thereafter round that number of to the nearest greater number which is a multiple 2 raised to k, I.E 1, 2, 4, 8 . . .

In one embodiment, the average circuit is dynamic, in that N may have the values 1, 2, 4 . . . N depending on the number of photo diode segments that have a signal value above the threshold value. N is selected to avoid saturation in the circuit.

In still another embodiment the array is divided into a number of sub intervals, e.g. 32 for an array of 1024, whereby each subinterval comprises 32 photo diode segments. Each sub interval is provided with a full set of iterative signal processing circuits.

### Embodiment 2.4 Successive Averaging and Threshold with Divide by 2 Bins

Description

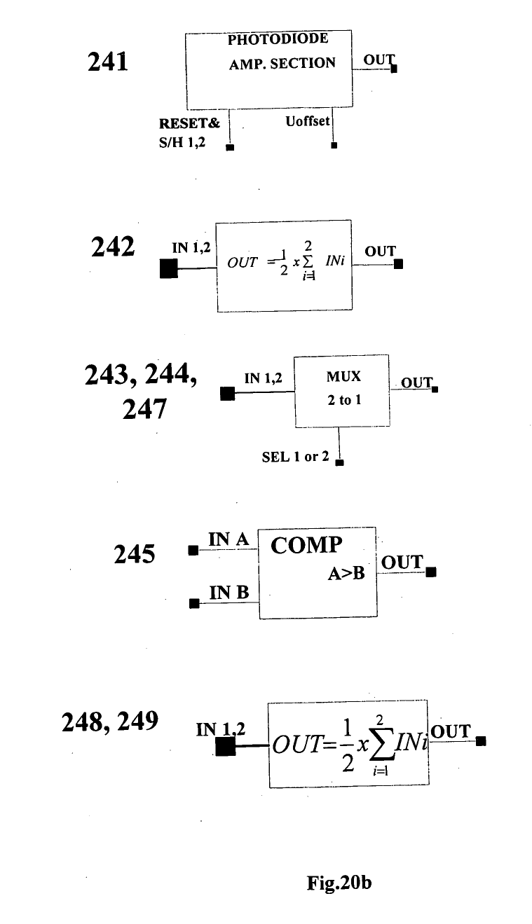

One example of a circuit design is shown in FIG. 20.

This methodology is based on the same circuit-topology as Methodology 1.2 except for that the compare 2 by 2 network has been replaced a division and iteration sequence circuit.

The description for a 16-pixel linear array goes as follows.

First there is a section of PDA circuits 241. An average by two circuit 242 is connected to the PDA circuits in a two by two fashion, where

$$OUT = \frac{1}{2} {\sum }_{i = 1}^{2} IN i .$$

A 2 to 1 multiplexer, 243 is connected in parallel with the average circuit. These two circuits are then connected to a 2 to 1 multiplexer 244. The circuits 242, 243 and 244 is a cluster that is repeated in three stages which contains 8, 4, 2 of this cluster.

The last stage contains two circuit clusters which are connected to one of the inputs of two comparators 245. The other input on the two comparators is connected to a Division and Iteration sequence circuit 2410. The outputs from the two comparators 245 are then connected to the control inputs of two 2 to 1 multiplexers 247. The comparator outputs are also connected to a average by 2 circuit 249, were

$$OUT = \frac{1}{2} {\sum }_{i = 1}^{2} IN i .$$

The inputs of the 2 to 1 multiplexers are connected to two signals, one input is connected to a zero, 0 signal/value the second input is connected to its corresponding comparator input signal. The outputs from the 2 to 1 multiplexers are then connected to a average by 2 circuit 248, were

$$OUT = \frac{1}{2} {\sum }_{i = 1}^{2} IN i .$$

The two average by 2 circuits 248, 249 are then connected to the division and iteration sequencer circuit 2410.

Methodology

FIG. 9 shows a diagram that illustrates the operation of this embodiment.

This methodology is an iterative procedure were we bin the pixels into halves and calculates and thresholds the averages for the halves. The half that is above the threshold/average is then divided into two new halves. This means that we have halves that step wise has 8, 4, 2, 1 pixels for a 16-pixel linear array.

Please see the signal curve figure for how the methodology works for a “real” signal.

Iteration 1.

First iteration starts with that the threshold signal from the division and iteration sequence circuit is zero, 0. We assume that all the PDA signal/values is greater than zero, 0. This gives that the comparator outputs are all one, 1 and that the outputs from the 2 to 1 multiplexers 247 all have the average signal from each half of the array. From this can we calculate a new average which we output and thresholds the inputs signals with. This gives that one half is smaller and thereby becomes zero, 0 at the comparator and 2 to 1 multiplexer outputs.

Iteration 2.

The second iteration starts with that we divide the greatest half from Iteration 1 into two new halves. Then do we threshold against the last average from Iteration 1, which equals the greatest half average in that iteration step.

Iteration 3.

The third iteration starts with that we divide the greatest half from Iteration 2 into two new halves. Then do we threshold against the last average from Iteration 2, which equals the greatest half average in that iteration step.

Iteration 4.

The fourth iteration starts with that we divide the greatest half from Iteration 3 into two new halves, which in this iteration step turns out to be two single pixels. Then do we threshold against the last average from Iteration 3, which equals the greatest half average in that iteration step. This iteration step ends with that we find the PDA with the largest signal/value and the value it self.

### Embodiment 2.5 Successive Averaging and Threshold with Bin Size=\sqrt{Nₚᵢₓₑₗ}

Description

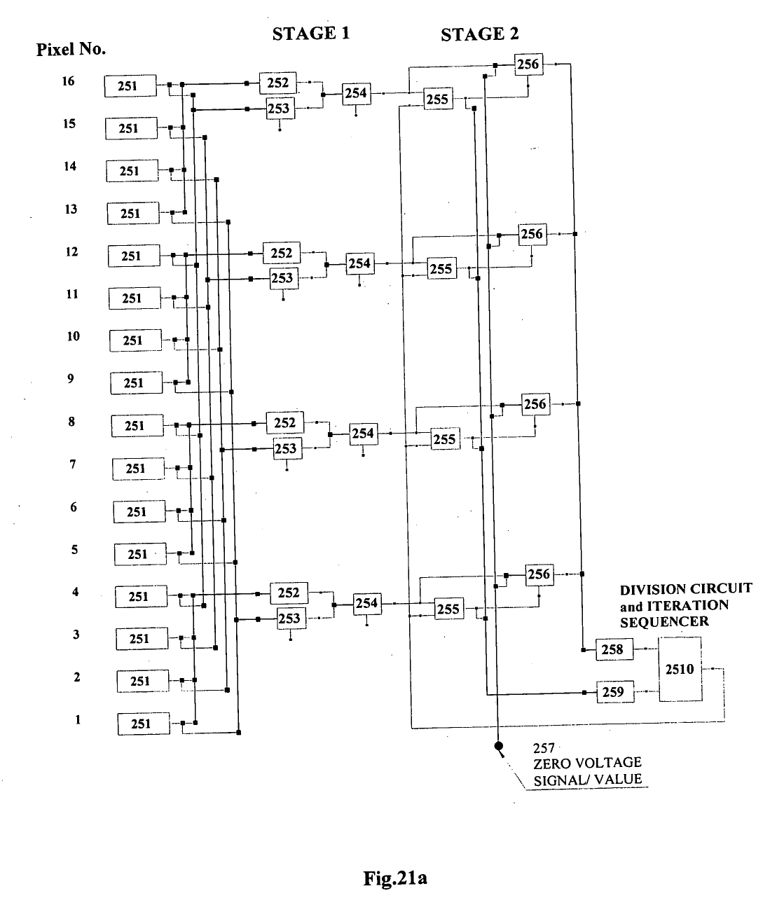

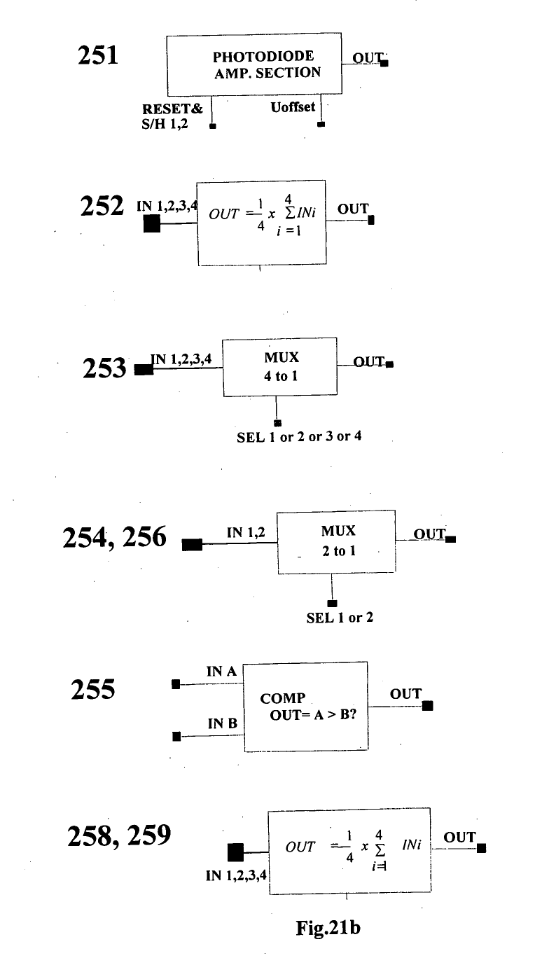

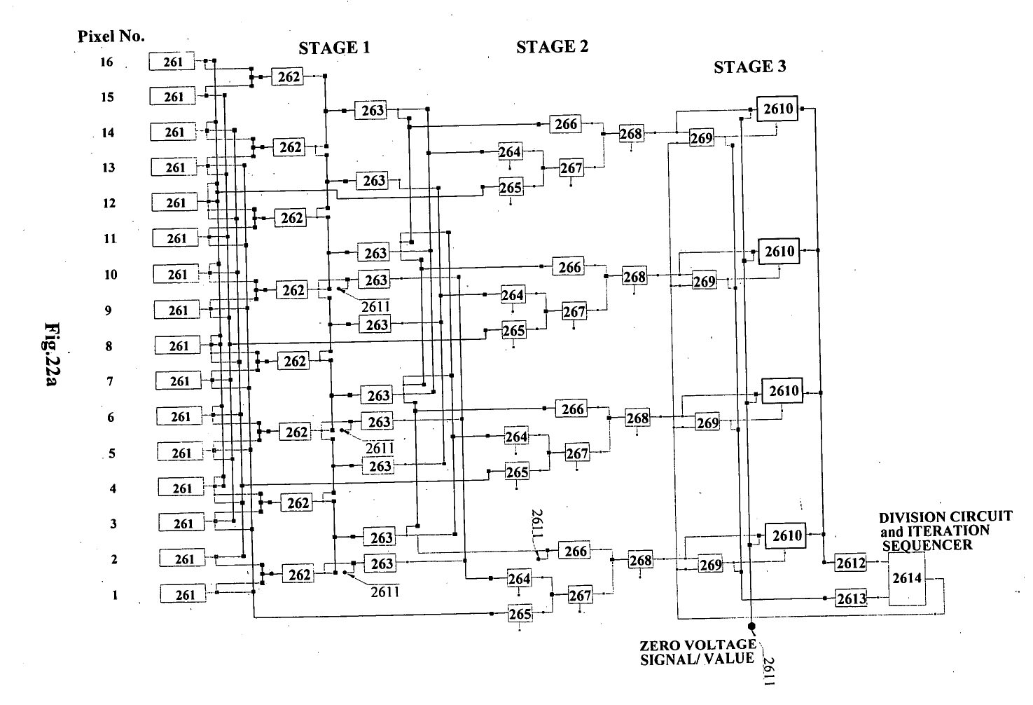

One example of a circuit design is shown in FIG. 21.

The circuit topology for this methodology resembles the circuit found for Methodology 1.3 The 16 signals from the PDA's 251 are grouped into four average signals/values 252

$$\begin{matrix}{A}_{1} = \frac{1}{4} * ( {S}_{1} + … + {S}_{4} ) , \\ {A}_{2} = \frac{1}{4} * ( {S}_{5} + … + {S}_{8} ) , \\ {A}_{3} = \frac{1}{4} * ( {S}_{9} + … + {S}_{12} ) , \\ and \\ {A}_{4} = \frac{1}{4} * ( {S}_{13} + … + {S}_{16} ) .\end{matrix}$$

Four 4 to 1 multiplexers 253 are connected to the 16 PDA's in following manner. To first multiplexer is PDA signals 1, 5, 9, 13 to second 2, 6, 10, 14 to third 3, 7, 11, 15 to fourth 4, 8, 12, 16. A 2 to 1 multiplexer 254 is connected to the average circuit and the 4 to 1 multiplexer.

The outputs of the 2 to 1 multiplexers 254 are then connected to one of the inputs of the comparators 255. The other input of the comparators 255 is connected to a Division and Iteration sequence circuit 2510. The control port of the 2 to 1 multiplexers 256 is connected to each comparator output. The PDA or Average by 4 signal is connected to one of the 2 to 1 multiplexer inputs, the other input of the 2 to 1 multiplexer is connected to a zero, 0 signal/value.

The outputs of the 2 to 1 multiplexers 256 are connected to a average by 4 circuit 258. The outputs of the comparators are connected to another average by 4 circuit 259. The average by 4 circuits is connected to the Division and Iteration sequence circuit 2510.

Methodology

FIG. 10 shows a diagram that illustrates the operation of this embodiment.

The methodology can briefly be described as that you first find the quarter with the largest average then you divide this quarter into is constituent pixels and find the largest PDA/pixel value.

Please see the signal curve figures during the description of the methodology.

First Step and Iterations:

The first iteration starts in that a threshold level that is zero, 0 signal/value is applied. Then the average by four for the 4 input averages is calculated. This new threshold level is imposed on the comparator inputs, all PDA signals smaller than the threshold is forced to be zero, 0 signal/value. This gives rise to a new calculation of an average and thereby threshold. The iterations are carried on until there is only one bin left that is bigger than the threshold value. When this occurs goes the process on to the second step.

Second Step and Iterations:

The second step starts in that the largest bin is divided into its pixels. Thereafter we start the iteration process and apply the last threshold value to the comparators. The values smaller than the threshold value are discriminated and are set to zero/0 signal/value. A new average and threshold is calculated and imposed onto the comparators, the process is continued until there is only one or two pixels left.

Embodiment 2.6 Successive Averaging and Threshold with Discrimination with Overlapping Bins

Description

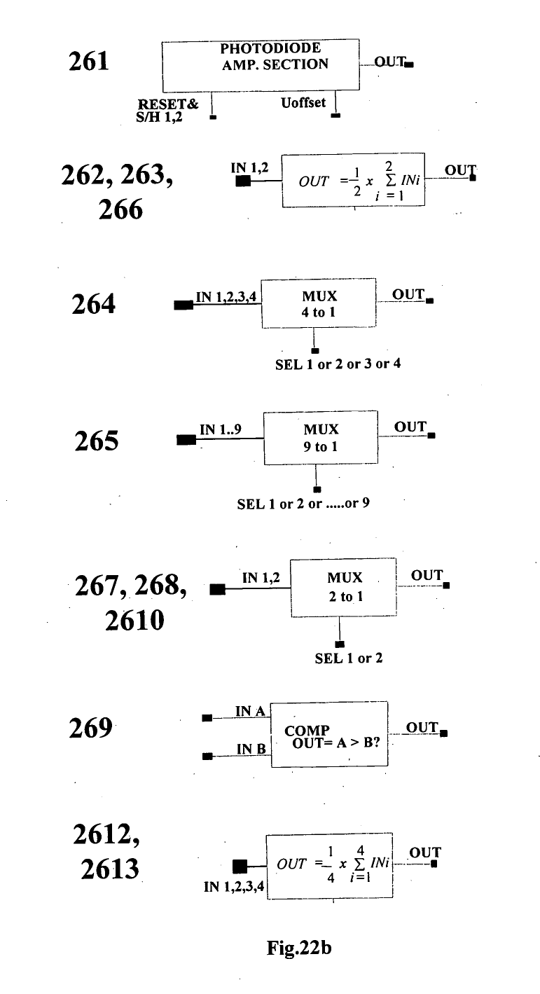

One example of a circuit design is shown in FIG. 22.

The circuit topology for this methodology goes as follows.

First there are 16 PDA circuits 261 which are connected two by two to a layer of average by 2 circuits 262. These average circuits are connected to a second layer of average by 2 circuits 263. These average by 2 circuits are connected in such a way that we generate a set of moving averages with an overlap of two. In between there is also a set of average circuits which are used to generate the fourth average value/signal in Step 2.

After the average circuits comes a circuit cluster that consists of one 4 to 1 multiplexer 264, one 9 to 1 multiplexer 265, thereafter another 2 to 1 multiplexer 267, in parallel with this multiplexer is a average by two circuit 266 and these two circuits are connected to a 2 to 1 multiplexer 268.

A set of 4 comparators 269 are connected to the 2 to 1 multiplexer 268. The threshold value, which is generated in the Division and Iteration sequence circuit 2614, is connected to the other input of the comparators 269. The output from the comparators 269 is connected to the control input of a 2 to 1 multiplexer 2610. The PDA/average signal is connected to one of the inputs of the 2 to 1 multiplexer 2610 and a zero/0 signal/value is connected to the other input. The outputs of the 2 to 1 multiplexers 2610 are connected to a average by 4 circuit 2612. The outputs of the comparators are connected to another average by 4 circuit 2613. The two average circuits are connected to the Division and Iteration Sequencer circuit 2610.

Methodology

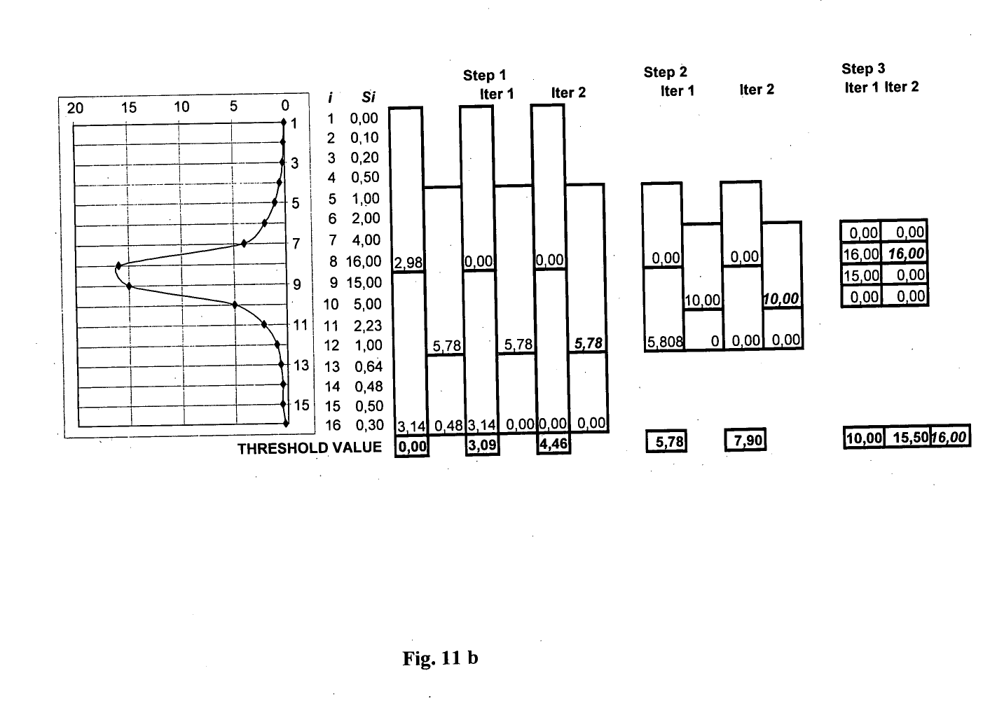

FIG. 11 shows two diagrams that illustrate the operation of this embodiment.

This methodology relies on that we in iterative steps find the largest bin average. The bins are overlapping to 50%. For a 16 pixel array does this mean that we carry out three steps with its iteration were we conclude which bin average was the largest at each step. In the last step do we find the pixel with the largest signal/value.

Step 1:

In the first Step the multiplexers 268 are set in such a position and connected to the average circuits 266 that we threshold the averages from four overlapping bins, BIN 1=S1 to S8, BIN 3=S9 to S16, BIN 2=S4 to S12 and BIN 4=S13 to S16. The first iteration in Step 1 starts with that we threshold against a zero/0 signal/value. Then we calculate the average from this and uses this new average signal/value as the new threshold value in Iteration 1. All PDA signals/values smaller than this threshold are discriminated and set to zero/0 signal/value. The second Iteration starts in that we calculate a new average with the discriminated signals and use it as threshold. This procedure continues until there is only one bin left. We use the iterative threshold with average and discrimination procedure to find the biggest of the four bin averages, were BIN 4=S13 to S16 is divided by 8 in order to ensure that it is not bigger than anyone of the other three averages.

Step 2:

In Step 2 are the two 2 to 1 multiplexers 267, 268, controlled so that the 4 to 1 multiplexer 264 is connected to the four comparators 269. The 4 to 1 multiplexers 264 are set in such a position that the bin with the largest average from Step 1 is now divided into four smaller and overlapping bins. The meaning of this is easiest to show if we take a look in the signal curve figure were for both curves the BIN 2 average was found to be the largest in Step 1. As can be seen from this figure is BIN 2 divided into four new smaller BIN's and their respective divide by 4 averages. This gives that we have four new signals connected to the threshold and discrimination network which we use to find the largest bin average. From the signal curve figure do we see that this was BIN 3 for the top curve and BIN 2 for the bottom curve.

Step 3:

In Step 3 do we control the multiplexers 267, 268, so the comparators network is connected to the 9 to 1 multiplexers 265. Then we use the result from Step 2 to control multiplexers 265 so that the four PDA's/pixels signals that formed the largest bin average in Step 2 are connected to the compare, threshold and discrimination network. From the signal curve figure do we see that last iteration gives that pixel/PDA signal 10 and 8 is found to be largest for the top and bottom curve respectively.

1. Position detecting device, comprising a photo detection element array having n segments and a parallel arithmetic processing portion that is arranged to identify the segment having maximum intensity by comparing the output values from the segments of the photo detection element array wherein the parallel arithmetic processing portion comprises at least one comparing stage that is arranged to successively select/deselect the segments, until the segment having maximum intensity is selected, the first stage receiving the output values from respective photo detection element segments as input segments and any additional stage receiving the output values from the preceding stage as input segments.

2. Position detecting element according to claim 1, wherein the parallel arithmetic processing portion comprises at least one pair-wise comparing stage that is arranged to pair-wise compare the output values of selected input segments, and for each such pair select the input segment with highest output value and deselect the input segment with lowest output value.

3. Position detecting element according to claim 2, wherein each pair-wise comparing stage, for each pair of input segments, comprises a select circuit comprising one comparator for selecting the input segment with the highest output value and one two-channel multiplexer that in response to the comparator provides the output value of the selected input segments at its output.

4. Position detecting element according to claim 1, wherein the parallel arithmetic processing portion comprises at least a first stage in the form of a block comparing stage that is arranged to divide the output values from selected input segments into at least two blocks, calculate the block average value of the output values for each block, compare the block average values, and select the block with the highest average value.

5. Position detecting element according to claim 4, wherein each block comparing stage comprises at least two select circuits,
each select circuit SC comprising a m channel input select multiplexer, an m channel average circuit, and a 2 channel output select multiplexer
the average circuit receiving as input the output values from m input segments and providing the average of the output values from the input segments as output
the input select multiplexer receiving as input the output value from one of the m input segments connected to the average circuit in the same select circuit and output values from m-1 input segments connected to average circuits in other select circuits, and providing the selected one of these as output
the output select multiplexer receiving as input the output from the average circuit and the input select multiplexer, and providing the selected one of these two as output to the next stage.

6. Position detecting element according to claim 5, wherein if a block comparing stage is preceded by another block comparing stage, each average circuit is arranged to receive as input the outputs from m average circuits in the preceding stage, while the input select multiplexers are arranged to receive as input the outputs from one of the m output select multiplexers of the select circuits in the preceding stage connected to the average circuit in the same select circuit and output values from m-1 output select multiplexers of the select circuits SC in the preceding stage connected to average circuits in other select circuits SC.

7. Position detecting element according to claim 4, wherein it comprises at least two block comparing stages that compares the same set of input segments but divided into blocks overlapping the block edges in the other stage, so that a peak output value located close to a block edge in one stage is not close to a block edge in the other stage, whereby the average output value for that block will be higher than from all other blocks, said block is selected.

8. Position detecting element according to claim 1, wherein the parallel arithmetic processing portion comprises a threshold comparing stage arranged to compare the output values from all selected input segments with a threshold value and deselect all input segments having an output value lower than the threshold value.

9. Position detecting element according to claim 2, wherein the parallel arithmetic processing portion comprises a sufficient number of pair wise comparing stages to deselect all but one of the n segments.

10. Rangefinder wherein it comprises a position detecting element according to claim 1.
